(19) United States
(12) Patent Application Publication
(10) Pub. No.: US 2010/0276442 A1
(43) Pub. Date: Nov. 4, 2010

(54) PERSONALIZED DRY OR BULK DISPENSING SYSTEM

(75) Inventors: KAREN J. QUERFURTH, COLOMA, MI (US); AMERESH B. VISWANATHAN, SAINT JOSEPH, MI (US); RONALD L. VOGLEWEDE, SAINT JOSEPH, MI (US); MICHELE E. WILCOX, STEVENSVILLE, MI (US)

Correspondence Address: WHIRLPOOL PATENTS COMPANY - MD 0750, 500 RENAISSANCE DRIVE - SUITE 102, ST. JOSEPH, MI, 49085, US

(73) Assignee: WHIRLPOOL CORPORATION, BENTON HARBOR, MI (US)

(21) Appl. No.: 12/434,121

(22) Filed: May 1, 2009

(51) Int. Cl. B65D 83/00; F25D 23/02; G05D 23/00; B67D 5/06

(52) U.S. Cl. 222/1; 62/449; 62/377; 700/299; 222/307; 222/305; 222/368; 222/142

(57) ABSTRACT

An appliance with a rear wall section, a first side wall section, and a second side wall section, defining an interior. The appliance includes a refrigerator section within the appliance interior and the refrigerator section has the same or a smaller volume than the appliance interior. The appliance also includes a door with an exterior surface and an interior surface with a door liner. Further included is a module removably engaged with the appliance. Yet further included is a resealable comestible dry goods container having a defined interior volume, an exterior, and a bottom portion where the container is removably engaged within the module.

### BACKGROUND OF THE INVENTION

Refrigerators are available in many styles, with the most common styles including both a refrigerator compartment and a freezer compartment, which may be side-by-side or one on top of the other. Controls regulate the temperature in each compartment, but otherwise there is very little control over the precise temperature, humidity, pressure, gas composition, and other variables in each respective compartment. Thus, within each refrigerator or freezer compartment, the conditions are substantially uniform throughout the compartment.

While refrigerator compartments generally do a good job of preserving food items for a short period of time, different foods, beverages, and non-food items require different conditions for maximum preservation. Storage techniques of food in the compartment can also affect the shelf life of the food item. Generally, food preservation in the refrigerator or freezer compartments is limited to a shorter time than is desired by many consumers. Perishability is typically caused by microbial degradation, enzymatic activities, and chemical reactions which may result in changes in safety, sensory, and nutritional quality of the food.

Additionally, various methods of measuring and dispensing comestible dry goods can be uncleanly and inefficient. Using measuring cups on areas such as a countertop typically will lead to at least some waste of the goods, as spilling leads to an inefficient use of the dry goods. Spillage during metering and dispensing also creates untidiness in the area. Inefficiency and untidiness associated with manual measurement and dispensing of dry goods are both commonly considered unpleasant to a consumer.

### SUMMARY OF THE INVENTION

One object of the present invention is to provide an appliance with a rear wall section, a first side wall section, a second side wall section, at least one door, a top, and a bottom that define an interior of the appliance. A refrigerator section is typically included within the appliance interior. The refrigerator section may have the same or a smaller volume than the interior of the entire appliance. The door(s) have an exterior surface and an interior surface having a door liner and a cavity. Further included is a module removably engaged with the appliance. Yet further included is a resealable comestible dry goods container having a defined interior volume, an exterior, and a bottom portion wherein the container is removably engaged within the module.

Another object of the present invention is to provide a portable dry goods storage and dispensing unit capable of engaging the interior surface of a door of a refrigeration appliance. Included is a module capable of being engaged and disengaged with an interior surface of a refrigerator door. The module further includes at least one, and more typically a plurality of, resealable comestible dry goods container(s) having a defined interior volume, an exterior, and a bottom portion. The container(s) are removably engaged with the module and include a metering and dispensing mechanism positioned proximate the bottom portion of the container such that the mechanism controls content output amount of dry goods from the container's interior volume. The module is also typically capable of maintaining a storage effecting condition (humidity, temperature, pressure, gas composition, and combinations thereof), within the interior of the module and/or the individual containers. The temperature of the interior volume of the container is independently controlled and the humidity of the container is independently maintained by a humidity controller (i.e., a desiccant, a salt packet, or a heater). The container(s) typically further include a resealable, typically substantially air tight or air tight, removable lid on each of the containers. In one embodiment, the desiccant may be removably engaged to the container interior facing surface of the lid.

A further object of the present invention includes a method for a user to store and dispense comestible dry goods. The method generally involves providing an appliance with a refrigerator section and an appliance door that provides access to the refrigerator section and having an exterior surface and an interior surface, the interior surface having a door liner. The door typically includes a module engaging connector for providing at least electrical power to a module. The module that is removably engaged with the door's interior and sized to fit within the door liner is also utilized in the method. The module also typically contains a utility connector that matingly and operatively connects with the module engaging connector of the appliance to supply at least electrical power to the module. Also provided is a resealable comestible dry goods container (or more than one container) that is removably engaged within the module and typically seated within a bottom portion of the module. The container has an interior volume, an exterior, and a bottom portion. The module, or more typically the container, further includes a metering and/or dispensing mechanism positioned proximate the bottom portion of the container and typically below the dry goods output aperture in the bottom of the container. The mechanism controls content output amount of dry goods from the container's interior volume. The user engages the module with the interior of the door, which typically includes operably connecting the module engaging connector to the module utility connector thereby providing at least electrical power from the refrigerator and to the module. The resealable comestible dry goods container(s) are engaged with the module either before or after the container is filled with a dry good by inserting at least a portion of the container into a receiving port or section of the module. Thereafter, a desired content output amount of dry goods from within the container interior volume can be metered and dispensed out of the container by the user. The amount dispensed is typically a user defined output amount.

Additional objects, features, and advantages of the present invention will become more readily apparent from the following detailed description of the preferred embodiments when taken in conjunction with the drawings wherein like reference numerals refer to corresponding parts in the several views.

### BRIEF DESCRIPTION OF THE DRAWINGS

FIG. 1 is an elevational front view of an appliance with a refrigerator section;

FIG. 1A is an elevational front view of the refrigerator section including a module and dry or bulk goods storage and dispensing containers mounted in the module;

FIG. 2 is an upper right perspective view of the module and the dry or bulk goods storage and dispensing containers;

FIG. 2A is an upper right perspective view of the module further illustrating the dry or bulk goods storage and dispensing containers;

FIG. 3 is an elevational front view of the module and the dry or bulk goods storage and dispensing containers;

FIG. 4 is an elevational side view of the module and the dry or bulk goods storage and dispensing containers;

FIG. 5 is an elevational side view of the module just prior to engaging the refrigerator door;

FIG. 5A is an elevational side view of module engaging the refrigerator door;

FIG. 5B is an elevational side view of module engaged with the refrigerator door;

FIG. 5C is an elevational side view of a refrigerator door port area after removal of the module;

FIG. 6 is an exploded perspective view of the dry or bulk goods storage and dispensing container;

FIG. 6A is an exploded perspective view of the dry or bulk goods storage and dispensing container;

FIG. 6B is a perspective view of the dry or bulk goods storage and dispensing container;

FIG. 7 is an upper right perspective view of the module engaging a countertop stand illustrating the portability of the module;

FIG. 7A is a rear perspective view of the module prior to engaging the countertop stand illustrating the portability of the module;

FIG. 7B is a rear perspective view of the module engaging a countertop stand illustrating the portability of the module;

FIG. 8 is a front right perspective view of the module prior to engaging a mounted wall bracket illustrating the portability of the module;

FIG. 9 is an elevational front view of a first embodiment of a rotatable dispensing member with large spacing;

FIG. 9A is an elevational front view of a first embodiment of the rotatable dispensing member, with large spacing, rotating to illustrate dispensing of the dry or bulk goods;

FIG. 9B is a perspective view of a first embodiment of the rotatable dispensing member with large spacing;

FIG. 10 is an elevational front view of a first embodiment of a rotatable dispensing member with medium spacing;

FIG. 10A is an elevational front view of a first embodiment of the rotatable dispensing member, with medium spacing, rotating to illustrate dispensing of the dry or bulk goods;

FIG. 10B is a perspective view of a first embodiment of the rotatable dispensing member with medium spacing;

FIG. 11 is an elevational front view of a first embodiment of a rotatable dispensing member with small spacing;

FIG. 11A is an elevational front view of a first embodiment of the rotatable dispensing member, with small spacing, rotating to illustrate dispensing of the dry or bulk goods;

FIG. 11B is a perspective view of a first embodiment of the rotatable dispensing member with small spacing;

FIG. 12 is a perspective view of a second embodiment of the dry or bulk goods storage and dispensing container;

FIG. 13 is an exploded view of a second embodiment of the dry or bulk goods storage and dispensing container;

FIG. 14 is a perspective cross-sectional view of a second embodiment of the metering and dispensing member of the dry or bulk goods storage and dispensing container;

FIG. 14A is a cross-sectional view of a second embodiment of the metering and dispensing member of the dry or bulk goods storage and dispensing container;

FIG. 14B is a perspective cross-sectional view of a second embodiment of the metering and dispensing member of the dry or bulk goods storage and dispensing container illustrating the metering device in motion;

FIG. 14C is a cross-sectional view of a second embodiment of the metering and dispensing member of the dry or bulk goods storage and dispensing container illustrating the metering device in motion;

FIG. 14D is a perspective cross-sectional view of a second embodiment of the metering and dispensing member of the dry or bulk goods storage and dispensing container illustrating dispensing of the dry or bulk goods;

FIG. 15 is a perspective view of a third embodiment of a dry or bulk goods storage and dispensing container;

FIG. 15A is an exploded view of a third embodiment of the dry or bulk goods storage and dispensing container;

FIG. 15B is a perspective view of a third embodiment of a dry or bulk goods storage and dispensing container;

FIG. 16 is an exploded view of a third embodiment of the dry or bulk goods storage and dispensing container;

FIG. 17 is a perspective view of a container partition for the dry or bulk goods storage and dispensing container;

FIG. 17A is a perspective view of a container partition for the dry or bulk goods storage and dispensing container;

FIG. 17B is a perspective view of a container partition for the dry or bulk goods storage and dispensing container;

FIG. 18 is a perspective view of a third embodiment of the dry or bulk goods storage and dispensing container;

FIG. 19 is a perspective view of the dry or bulk goods container with a conveyor slide in a closed position;

FIG. 19A is a perspective view of a dry or bulk goods container with a conveyor slide in an opened position;

FIG. 20 is an exploded perspective view of a recess within the container lid, housing a desiccant or a salt;

FIG. 20A is a perspective view of a lid with apertures, illustrating air flow between the recess and the container.

### DETAILED DESCRIPTION OF THE PREFERRED EMBODIMENTS

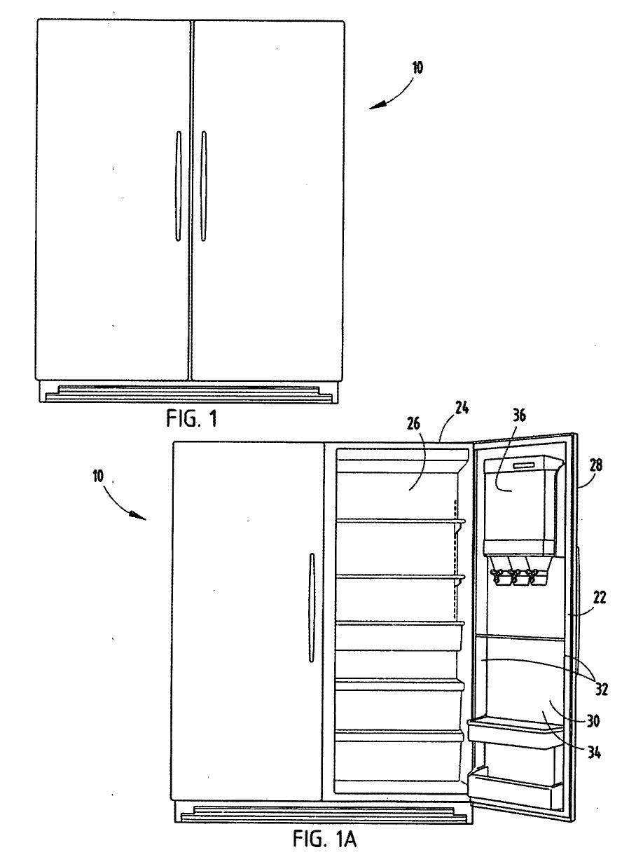

For purposes of description herein, the terms “upper,” “lower,” “right,” “left,” “rear,” “front,” “vertical,” “horizontal,” and derivatives thereof shall relate to the appliance as orientated in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The reference number 10 (FIGS. 1-1A) generally designates an appliance with a rear wall section 12, a first side wall section 14, a second side wall section 16, a top 18, a bottom 20, and at least one door 22 providing access to the refrigerator section 24 where the rear wall section, the first side wall section, the second side wall section, the top and bottom, and the door define an appliance interior 26. The refrigerator section within the appliance interior may have the same or a smaller volume than the overall interior of the appliance, i.e., the appliance may be solely a refrigerator or be an appliance having both a refrigerator section and another section, such as a freezer section. The door(s) of the appliance have an exterior surface 28 and an interior surface 30 typically having a door liner 32. The liner is typically formed with a cavity or pocket 34 for receiving one or more modules with the same or different features. For example, in addition to the dry goods dispensing and/or metering module 36 of the present invention, modules that, for example, produce a modified atmosphere to preserve food such as those disclosed in commonly owned U.S. patent application Ser. Nos. 12/346,682 and 12/343,690, the disclosures of which are hereby incorporated by reference in their entireties, may also or alternatively be coupled with the appliance.

The illustrated appliance 10 is shown with the door 22 hingably attached to the appliance. The door covers at least a portion of the refrigerator section 24 that lies within the appliance interior 26, and as shown, the door is in an opened position. The door has an exterior surface 28 and an interior surface 30, with the interior surface exposed in the opened position. The door liner 32 at least partially covers, but more typically covers all or substantially all of the interior surface 30 of the door 22. An interface between the modules and the appliance door, such as interconnecting tabs and grooves or a magnetic engagement, allows for quick and easy installation docking without the use of tools. Differently sized modules may be accommodated through the use of spacer systems that engage the interior of the door and shorten the lateral distance that the module must traverse to engage the spacer. The spacer, when used, would mimic a smaller mounting distance/door pocket or cavity and similarly have an interface such as a tabular on groove mating or magnetic engagement.

The modular construction and interchangeability of modules minimizes manufacturing costs and allows the module to be original equipment or after-market components retro-fit into appliances, after the initial purchase and installation of the appliance in a consumer's home. This interchangeability provides flexibility and improved food preservation and storage for the consumer, improved choice of modules with opportunity to upgrade or replace without replacing the whole refrigerator based upon lifestyle or life stage changes, and allows the consumer to take advantage of new technology improvements and new features as new modules are designed and developed.

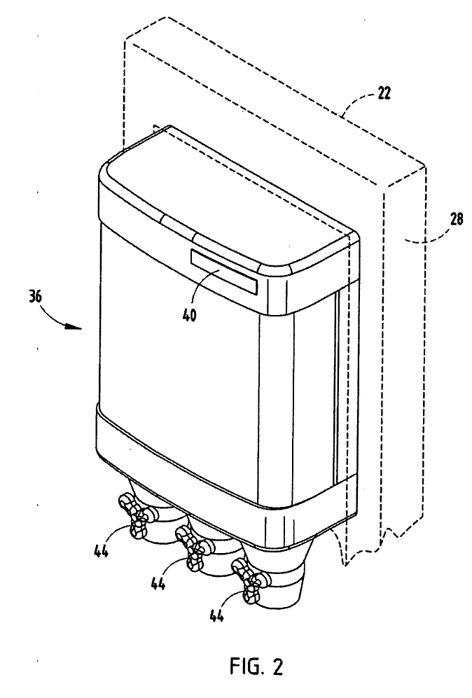

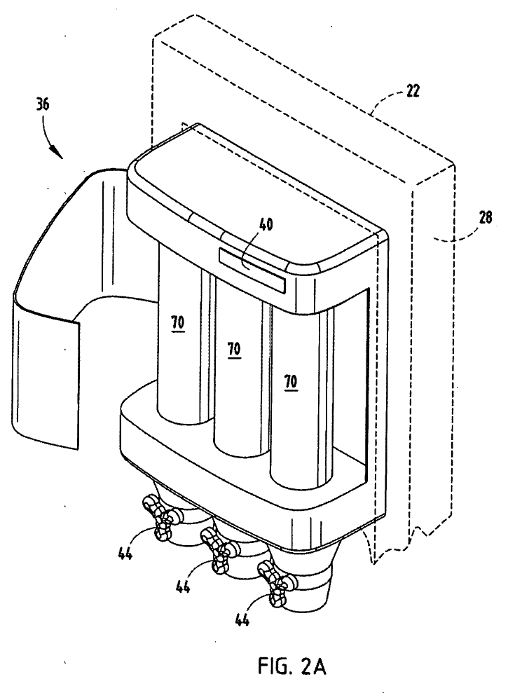

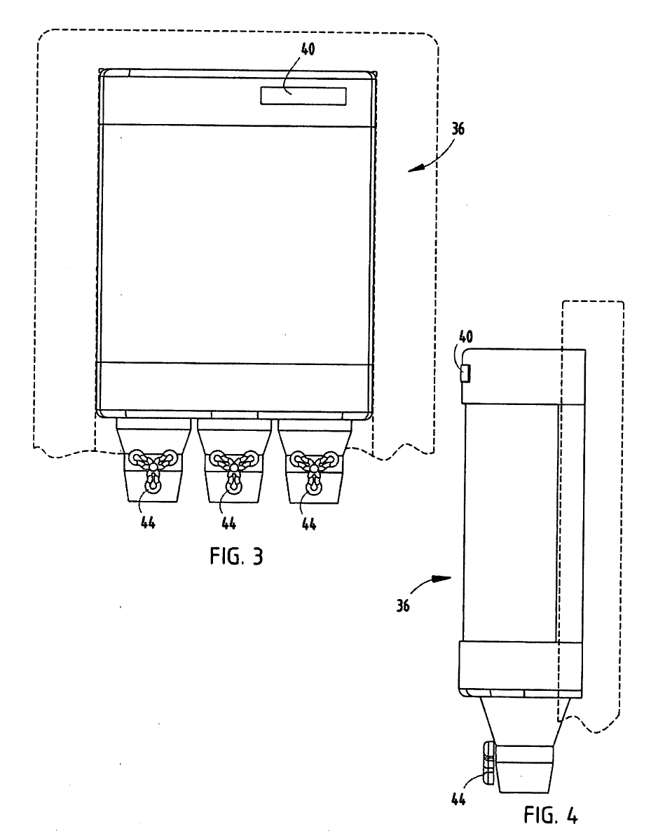

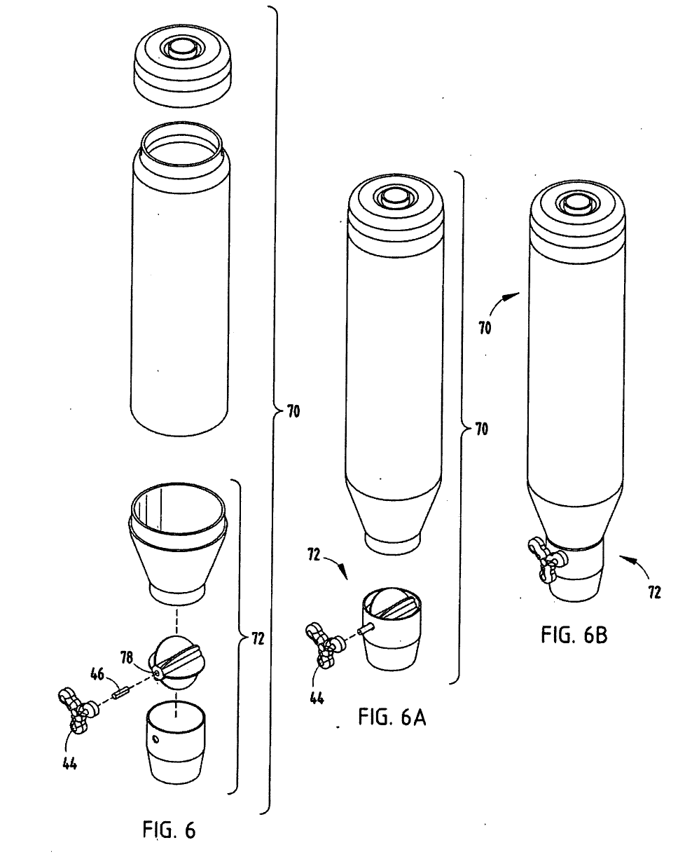

A dry goods dispensing and metering module 36 (FIGS. 1-8, 12) according to one embodiment of the present invention is removably engaged with the door 22 and sized to fit within the door liner 32, typically within the cavity or pocket 34 of the door liner, however connectivity to an exterior surface of the door may also be accomplished. Engagement of the module 36 with the door 22 occurs by engaging the module with the refrigerator door. The module can be engaged to the door 22 in any convenient manner, such as by interlocking tabs, a small support shelf or floor, or other mechanical means or a magnetic arrangement (for example, a magnet on each side of the module for attraction to magnets of opposite polarity on each side of the door liner) may also be used. When appropriate for the module 36, engagement of the module to the door 22 can automatically couple electrical and/or fluid lines in the door and in the module so as to provide functional features to the module. The door typically includes a module engaging connector 38 for providing the electrical power to the module. The door module engaging connector 38 may also provide one or more utilities such as fluids and chilled air to the module. Conceivably a separate utility connector could be used such that power is serviced differently from other utility or utilities. For the dry goods module of the present invention, typically only electrical power is applied to the dry goods module 36. When engaged with the appliance, the dry goods module of the present invention typically receives at least electrical power from the appliance 10.

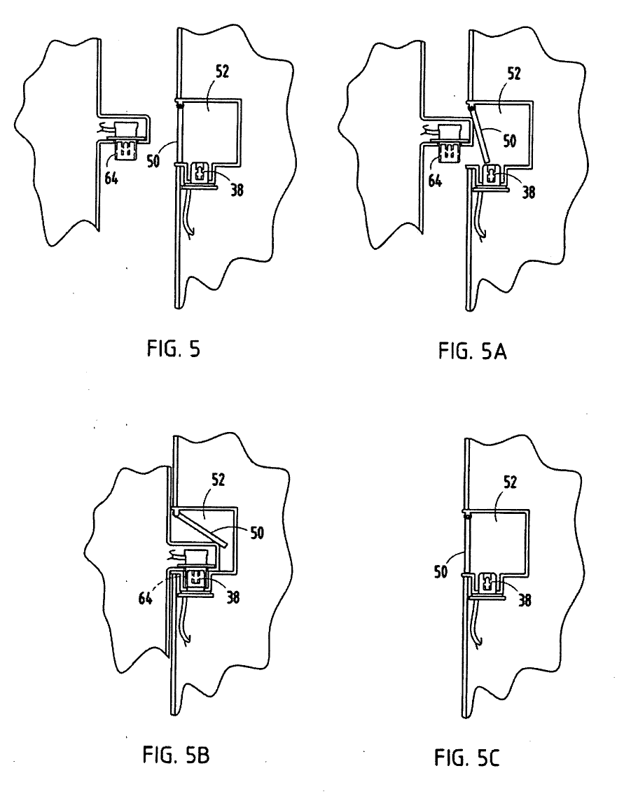

The door 22 may provide the ability to engage a plurality of modules to the appliance. FIGS. 5-5C generally illustrate the engagement of a module 36 to a door 22. Typically, a spring biased connection port cover 50 is hingably engaged with the liner 32 or door 22 such that when a module 36 is not engaged with the door, the connector with the port area 52, typically a female connector in the door 22 for engaging the module, is protected against debris from the food or other items stored in the appliance 10 that would potentially block or hamper operable connection of the module 36.

While a push switch as discussed above may be used, alternative electrical engagements of the module 36 with the door 22 may be used instead of, or in addition to, the push switch. A Reed switch may be provided in the door liner for activation by a magnet imbedded in the side wall of the module so as to complete an electric circuit when the module docks into the door pocket. Contact pads on the liner and on the module that complete the electrical circuit when the module is mounted in the door liner may also be employed.

In addition to being engaged with the door 22 of an appliance 10, the module 36 of the present invention may optionally be engaged with a countertop stand 60 and/or a wall bracket 62. The countertop stand 60 and wall bracket 62 would typically also include a connector (typically a female connector) within a port area protected by a spring-biased port cover. The module typically draws electrical power and optionally other utilities.

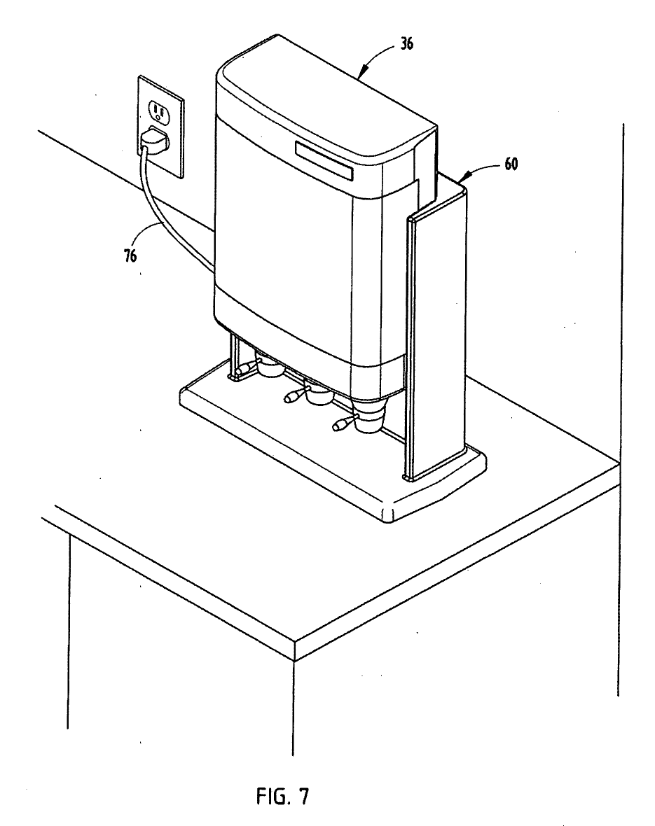

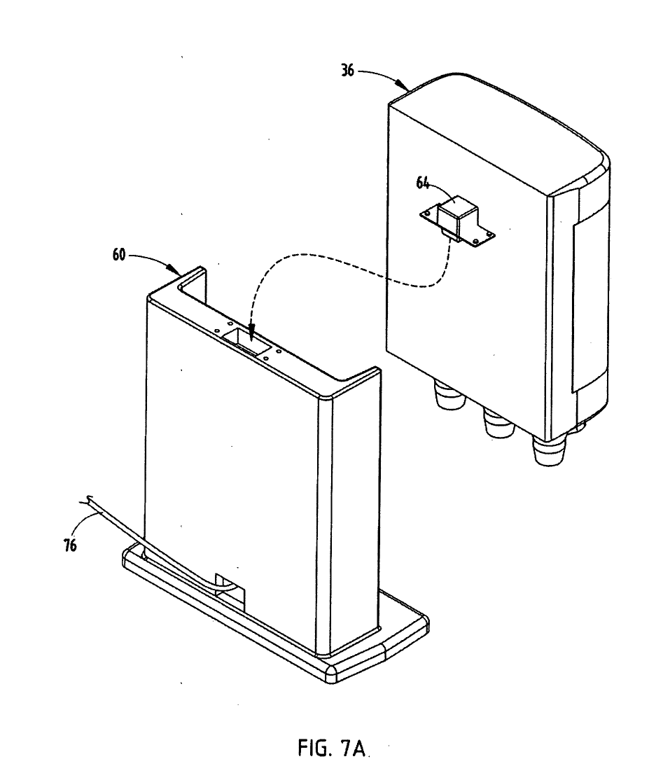

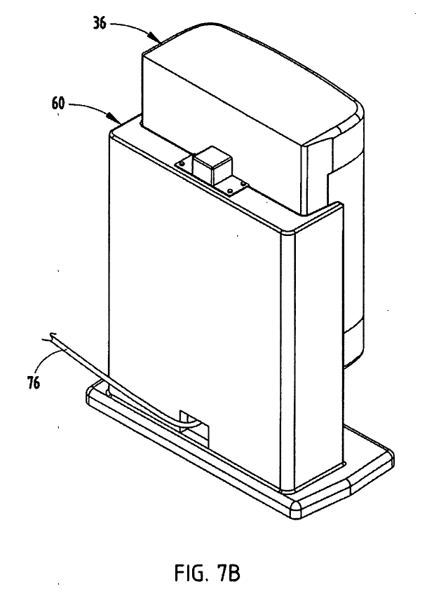

When a countertop stand 60 is utilized, as shown in FIGS. 7-7B, the stand typically includes a base and an upright section that substantially mimics a pocket or cavity of a refrigerator or other appliance door liner. The module 36 typically engages the sides of the countertop stand 60 for retaining the module in place via interlocking tabular members, and/or a pin type arrangement or other mechanical means or magnetically as described above. Typically, as when the module engages the interior door 22 of the appliance 10, the countertop stand 60 or wall bracket 62 includes a spring biased hinged cover that inwardly pivots when the module's connection plug (typically male-type) is inserted therein. The cover, as discussed before, prevents debris and other materials from contacting the module engaging connector of the countertop stand and/or wall bracket. The module 36 typically contains a generally L-shaped connection plug 64 (male-type) that is inserted into the cavity containing the module engaging connector thereby moving the cover inward about the hinge. The module is engaged with the module engaging connector when the module is tilted into position and dropped into engagement with the countertop stand 60, wall bracket 62, or door 22. This configuration is generally shown in FIGS. 7-7B. The countertop stand itself may draw electrical power from a separate outlet or directly from the appliance via an umbilical utility cord 76 type attachment. The utility cord from the appliance could also conceivably supply cold air or liquid or other utilities to the module.

At least one, but more typically a plurality of resealable, comestible dry goods container(s) 70 having a defined interior volume, an exterior, and a bottom portion are removably engaged with the module 36 for ease of filling and cleaning (the container(s) are typically dishwasher safe) and sized to fit into a standard dishwasher. The container also typically includes a metering and dispensing mechanism 72 positioned proximate the bottom portion of the container, such that the mechanism controls the output amount of the dry goods within the container's interior volume when the dispensing mechanism 72 is actuated by a user of the module. Dispensement may occur at an interior or exterior region of the appliance, regardless of the module position. In the situation where the module is engaged to an interior region of the door or appliance and dispensing occurs at an exterior region of the appliance, an access door or recess may be provided, similar to that of an ice maker output area. To facilitate dispensement in this configuration, an opening in the door or appliance located adjacent the dispensing mechanism 72 allows the dry goods to fall similar to that of ice in an ice maker, via gravitational force. Conceivably, a substantially vertically aligned channel or conduit may be connected to the dispensing mechanism 72, thereby allowing for transport of the falling dry goods to the access door or recess area.

The mechanism's metering device may be adjustable such that it can, based upon user input or selection, dispense a variety of amounts of a given dry good accurately. In another embodiment, individual containers may utilize a specified dispensing mechanism suitable for a given dry good to be dispensed. For example, if dry cereal or other high volume bulk material is stored, the typical serving may be one cup, the container may be metered to only dispense in one cup intervals or a predetermined non-adjustable amount. In this instance a gearing mechanism would not be necessary.

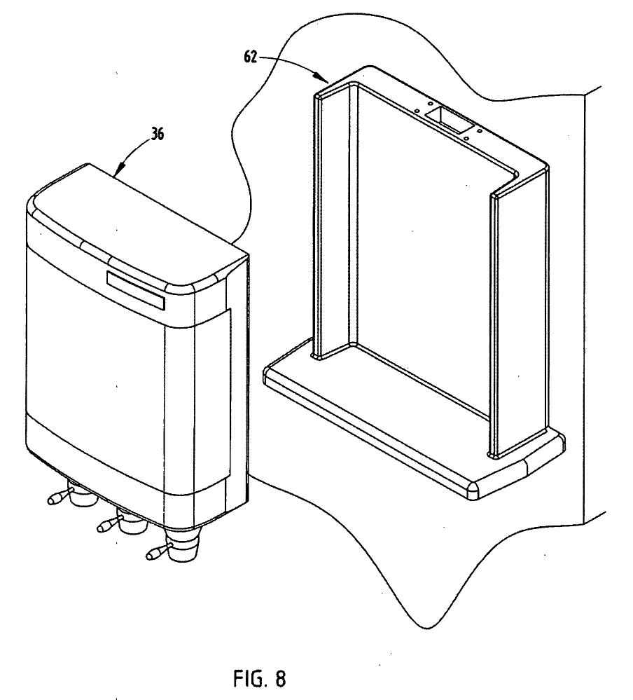

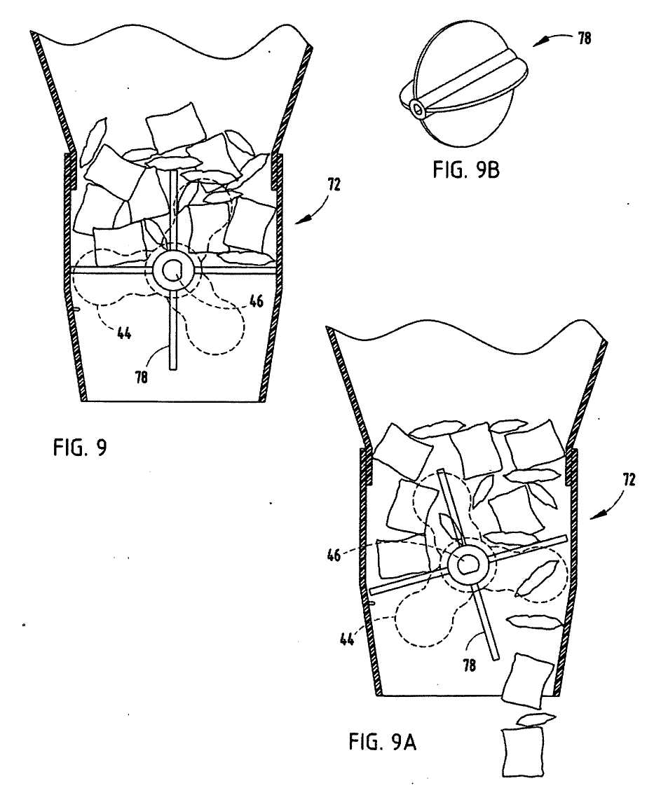

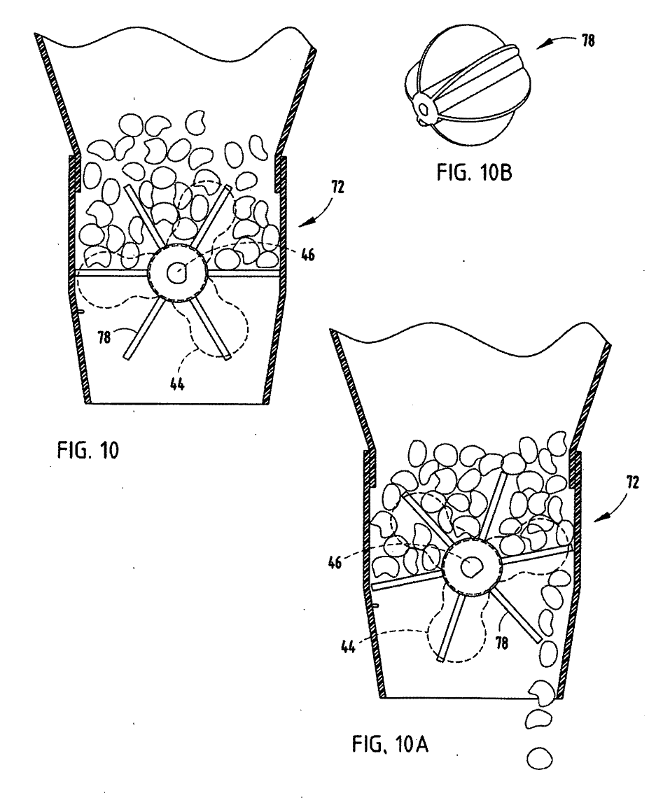

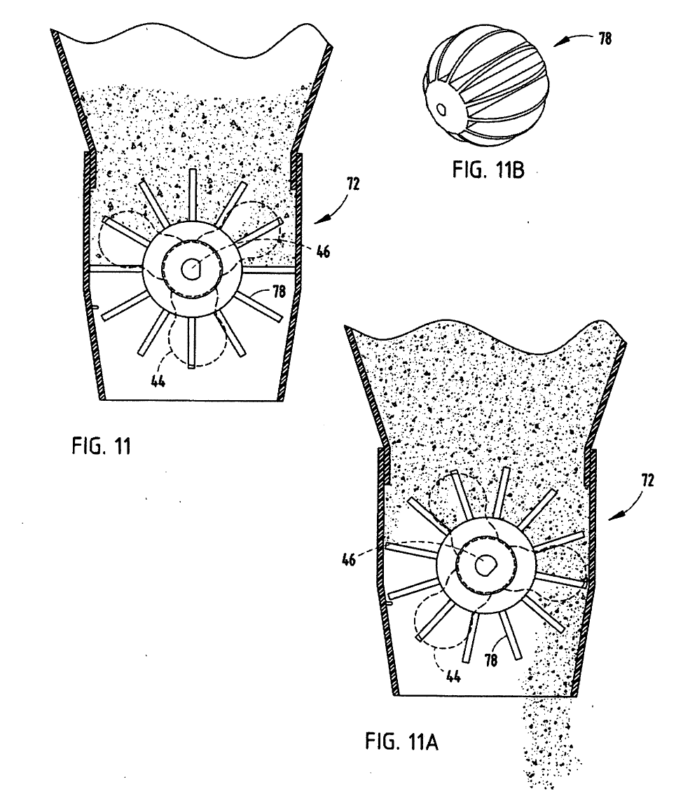

Additionally, the metering mechanism 72 may include a rotatable dispensing member 78 positioned below an aperture in the bottom of the container (FIGS. 9-11B). The rotatable member typically includes a plurality of equal sections and is operably connected to a user operated handle via a gear mechanism. The gear mechanism operates to adjust the extent of the rotation of the rotating member and thereby the amount of dry goods being dispensed. The sizes of the section of the rotatable member are typically provided in three general sizes. The rotatable member with the largest spacing (FIGS. 9-9B) allows for dispensing of high volume bulk goods such as cereals, and whole coffee beans. The medium sized sections (FIG. 10-10B) allow for the dispensing of medium sized dry good particles such as granola, raisins, and peanuts. The smallest spacing (FIG. 11-11B) allows for efficient dispensing of fine granular materials such as salt, sugar, or flour.

The metering and dispensing mechanism 72 is located proximate the bottom portion of the container, bag, or compartment. A user may input a desired output amount of the comestible dry goods to be dispensed manually (using for example, a rotatable dial) or by interacting with a user-interface display 40. The container may include a handle 44 on the exterior of the container, which in turn rotates a shaft 46 that is connected to the handle at a first end of the shaft. The shaft 46 is coupled to a gear system proximate a second end of the shaft. The gear system in one embodiment converts the rotational motion of the shaft to translational motion of a slide actuator. The slide actuator typically has one or more apertures sized to dispense the dry goods. Rotation of the handle 44, shaft 46, and gear system generates movement of the slide actuator to a position that corresponds to expelling of a user-desired input amount. A specific distance of a turn of the handle may correspond to a particular output amount. For example, a half rotation turn of the handle may correspond to metering and dispensing of one cup of a particular dry good. The type of comestible dry goods stored will vary and the same ratio of turn to output amount will not be uniform. Therefore, established ratios will be provided to a user, thereby allowing for easy conversions of output amounts.

In another embodiment, the gear system converts the rotational motion of the shaft into increased or decreased rotation of the rotating member of specified section volume (see discussion above), from which amounts may be determined.

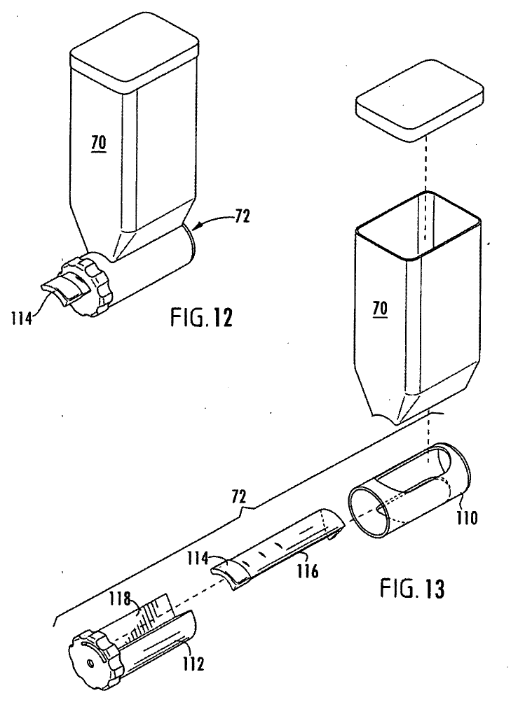

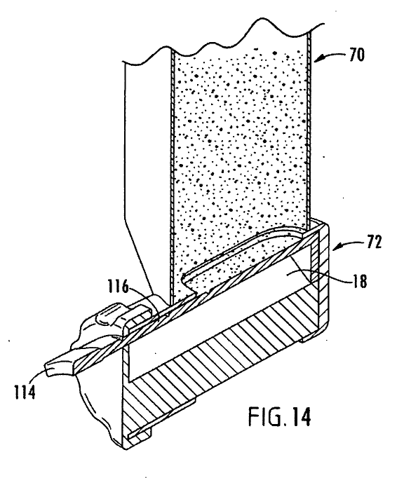

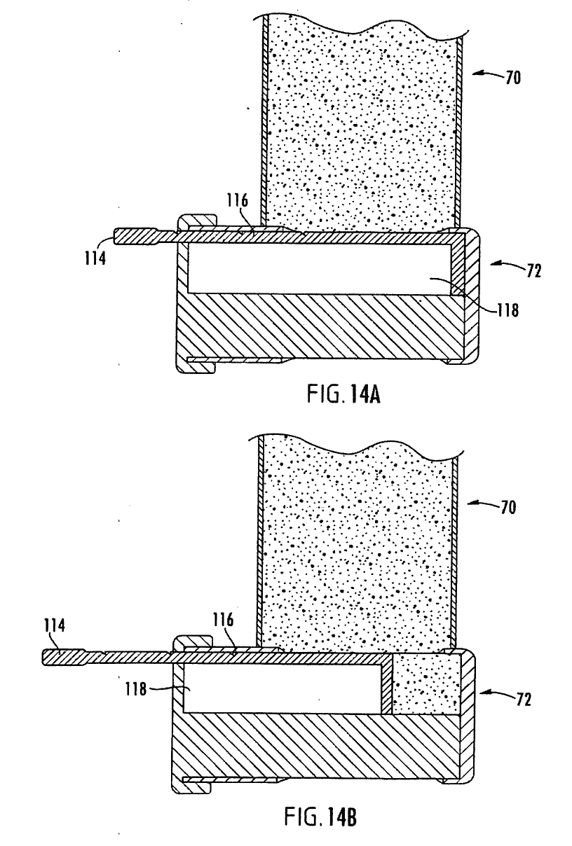

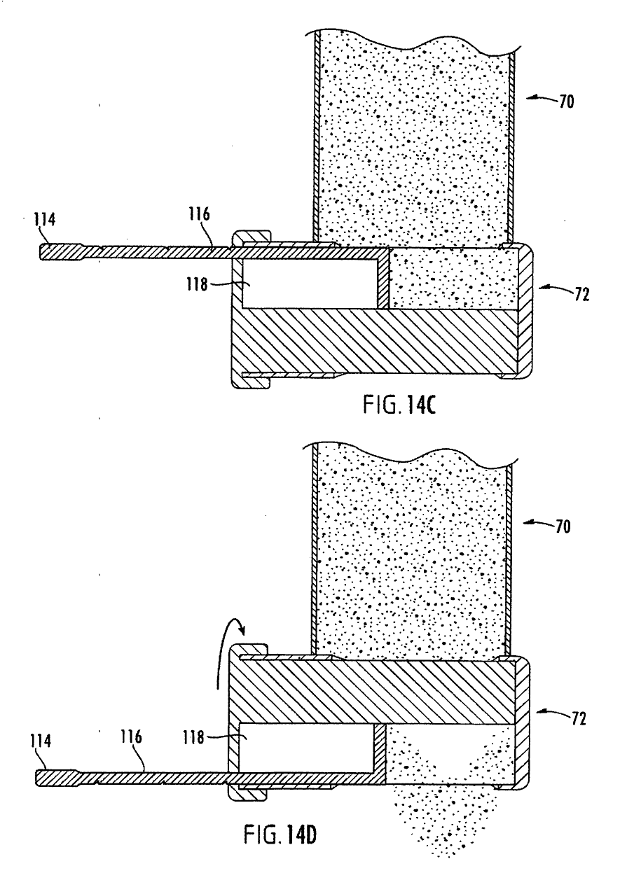

The metering and dispensing may also be accomplished by including at least one receptacle 112 within a rotatable cylinder 110 spaced proximate the bottom portion of the container (FIGS. 12-14D). The receptacle 112 has a manipulatable size that corresponds to a user-desired output amount of the container interior volume. A user may retract or expand the volume of each receptacle 112 in order to hold a desired amount of comestible dry goods. The dispensing mechanism is capable of expelling the contents of each receptacle upon command from the user, via manual means or by employing the user-interface display. In this embodiment a tumbler (elongated cylinder) with a cavity 118 (typically a trough with a triangular cross-section) is coupled to the handle 114 and a moveable (sliding) volume regulator 116 with a top and downward projection section that is spaced within the cavity of the tumbler and sized approximately the same as the cross-section of the cavity, travels back and forth as the amount to be dispensed is adjusted by the user to create a dispensing volume that is adjustable based upon the gearing to be employed. The handle 114 is turned to the loading position with the cavity facing upward toward the dry goods in the upper portion of the container and the dry goods fall into the cavity. Once filled, the cavity 118 rotates when the handle is actuated to a downward facing position, which results in the dispensing of the dry goods.

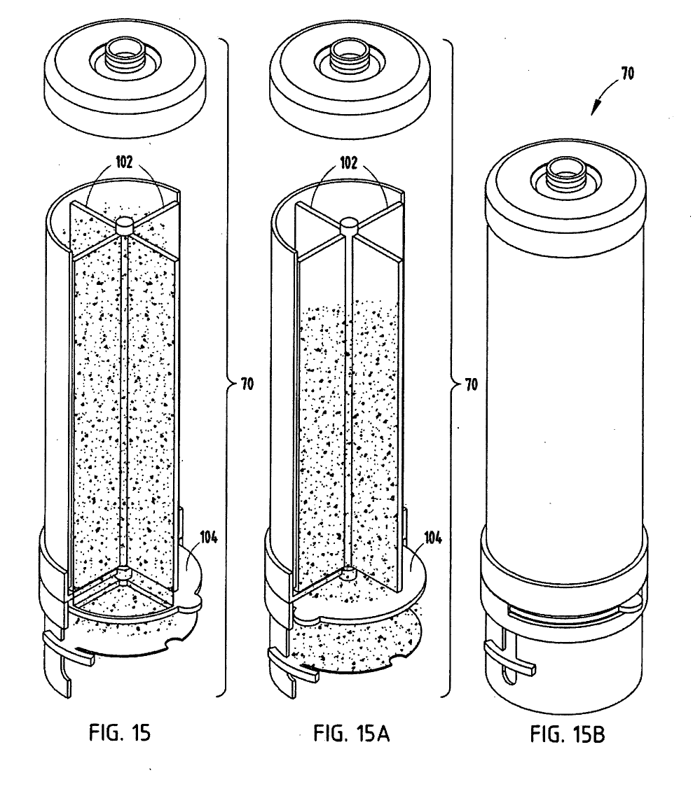

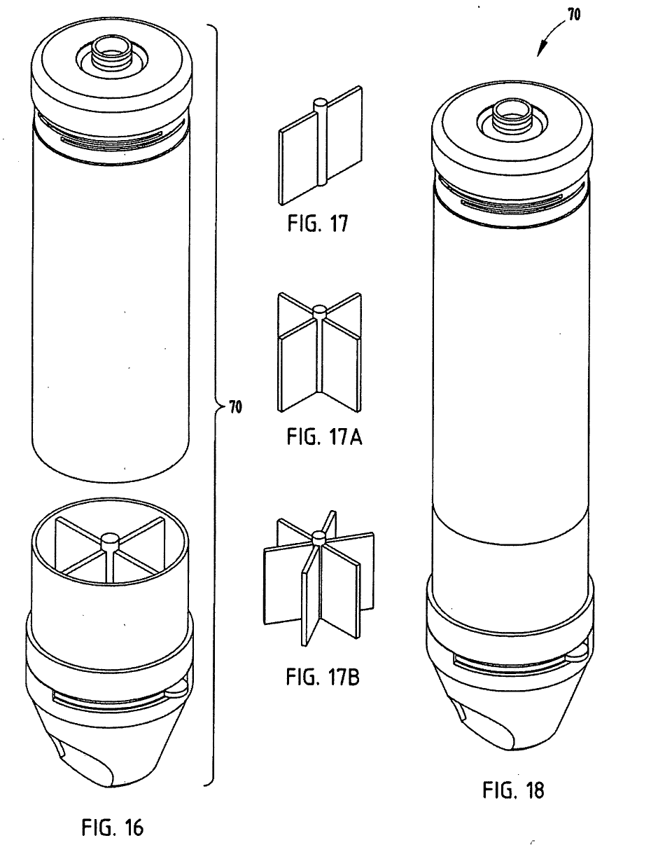

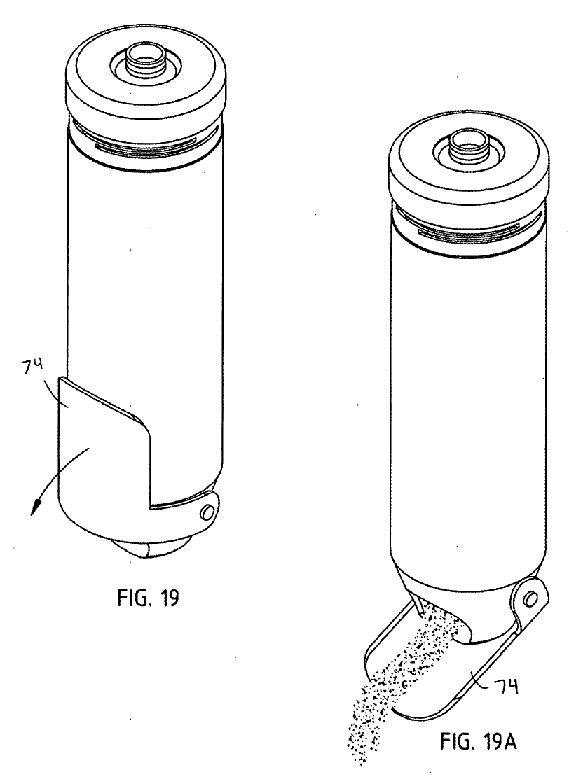

Another manner in which to meter and dispense the dry or bulk goods is illustrated in FIGS. 15-18. The containers include vertically elongated partitions 102 that form receptacles within each container. These volumes of the receptacles are manipulatable, thereby adjusting the storage capability of the receptacles. A slider 104 may move in a vertical fashion in order to accomplish the volume retractability. The movement of the slider may be actuated by a manual lever, a manual dial on the exterior of the container, or any other convenient means. The contents of each receptacle are dispensed by the turning of a crank or handle, or by interacting with the user-interface display.

Additionally, metering and dispensing may be accomplished by including a scale that weighs the output amount. The module, with data-stored densities of commonly-stored comestible dry goods, is capable of converting the weight of dispensed goods to volume. Dispensement occurs until the user-desired output amount is met.

The container or the module of the present invention typically further include a dry goods conveyor slide 74 that is rotatable between a position that dispenses dry goods in a direction away from the module for ease of use by the user (FIGS. 19-19A). The conveyor slide may fold or retract into a storage position (in addition to or instead of rotating) to allow for easy appliance door closure when the module is engaged with the interior surface of the door.

The containers of the storage and dispensing module are also typically resealable such that they form an air-tight or substantially air-tight seal on the container for the comestible dry goods. The container(s) typically have an interior volume, an exterior and a bottom portion. The bottom portion of the containers may include a dispensing mechanism or a dispensing and metering mechanism as discussed above. Alternatively, the dispensing or dispensing and metering systems may be incorporated into the bottom portion of the dry goods module itself. Typically, the containers operably engage with the module (typically by being slotted or placed within one or more sections of the bottom portion of the module). The sections may have a predefined area with generally U-shaped, upwardly facing channels for mating with the bottom edge rim of the containers, which are typically clear plastic. Usually, the containers are not tightly engaged with the module, but rather some small amount of movement or play (generally lateral movement) is desirable. It is presently believed that slight movement of the containers when the door of the appliance engaged with the module is opened and closed provides a deterrent or at least partially prevents caking of dry goods within the container.

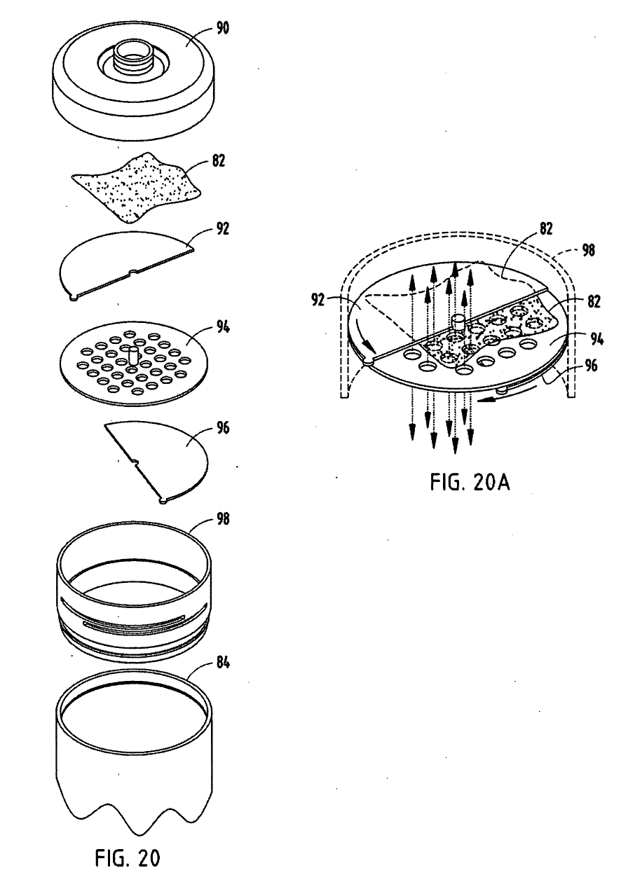

The storage and dispensing module may optionally maintain a storage effecting condition within the interior of the container (i.e., humidity, temperature, pressure, gas composition, and combinations thereof), which may be different from that of the atmospheric condition immediately surrounding the module. Typically, the module may maintain one more temperature, humidity, pressure, and/or gas levels. For example, the module may be capable of maintaining the container at a plurality of various temperatures, above, below, or at about ambient temperature. A desiccant 82, a salt or heater may be used to regulate humidity, which may be monitored by a sensor and the output of the sensor may be displayed or communicated to the user. A salt may be any compound formed when the acid hydrogen of an acid is partly or wholly replaced by a metal or a metallic radical, including, but not limited to, alkali metal salts such as sodium chloride. A desiccant disk that adjustably regulates humidity may be removably engaged with the container to treat humidity within the container (FIGS. 20-20A). For example, the desiccant may be placed within a recess in the container lid. Just under the container lid 90, the desiccant 82 rests on a aperture disk 94. The aperture disk has an upper cover 92 and a lower cover 96 that may both be adjusted to uncover a portion of the aperture disk. The entire humidity regulating recess rests within a jacket 98 that connects the container lid 90 to the container body 84. Conceivably, a single desiccant could regulate a plurality of containers if operably connected with the interior of more than one container to treat the humidity within the containers.

The module is capable of operably associating with a plurality of containers. Additionally, the module may be illuminated independently of the refrigerator section to enhance visibility of the containers engaged with the module, especially when the refrigerator door is open and the module engaged to the interior of the refrigerator door. The user-interface or a switch allows the user to illuminate the module, as needed. The module of the portable unit may also include a sensor that is capable of indicating a user predetermined level of container contents, so that prior to complete depletion of the dry goods material within the container, a user is warned of the low level. Like the storage effecting condition, this information could conceivably be delivered via computer network to a user defined electronic mail box/account or a mobile device such as a cellular telephone or an electronically kept grocery list via, for example, a computer networking device.

The present invention further provides a method for a user to store and dispense comestible dry goods. When in use, a user may engage a dry goods module according to an embodiment of the present invention with an appliance, typically a refrigerator door interior, a wall mounted bracket, or a countertop stand as described earlier. As discussed previously, typically the module is engaged with connectors on both the module and the wall bracket, countertop stand or the appliance such that at least electrical power is supplied to the module. Prior to or after the module is engaged with the appliance or other device, the removable container(s) of the modules are filled with one or more dry goods (each container having a different dry good or a mix of dry goods) and engaged with the bottom portion of the module. Usually this involves inserting the container or containers into a receiving port or location in the bottom portion of the module. Typically the bottom of the container has a perimeter rim that mates with one or more of the channels in the bottom portion of the module to seat the container and facilitate its holding in position. Next, the user can dispense the material. Optionally, when a metering mechanism is used, the user may set the amount of material to be dispensed through a user-interface, which may be a computer controlled interface or a manually controlled interface. Thereafter, the user may dispense the dry goods, which may be done manually by the user moving an actuator such as a handle operably connected to the dispensing mechanism or automatically using an electrical motor to actuate the dispensing mechanism.

The method of storing the dry goods may be enhanced by maintaining a storage effecting condition within the interior of the container. This step involves regulating humidity, temperature, pressure, and/or gas composition, either singularly or in combination. It should be noted that the disclosed method steps may be performed in various orders, not limited to the order presented here unless specifically so indicated.

It is to be understood that variations and modifications can be made on the aforementioned structure without departing from the concepts of the present invention, and further it is to be understood that such concepts are intended to be covered by the following claims unless these claims by their language expressly state otherwise.

1. An appliance comprising:
a rear wall section, a first side wall section, a second side wall section, a top, and a bottom and at least one door with an exterior surface and an interior surface having a door liner; and defining an interior comprising:
a refrigerator section within the appliance interior where the interior of the refrigerator section is the same size or smaller than the interior of the appliance;
a module removably engaged with the exterior surface or the interior surface of the door, wherein the module further comprises a resealable comestible dry goods container spaced at least partially having a defined interior volume, an exterior, and a bottom portion wherein the container is removably engaged within the module.

2. The appliance of claim 1, wherein the interior surface of the door further comprises a cavity and the module is removably engaged with the interior surface of the door and is sized to fit within the cavity and the module further comprises a computer control system operatively connected to the module and a sensor within the container interior volume, wherein the computer control system comprises a processor and a memory subsystem coupled to the processor where the memory subsystem stores code that, when executed based upon input received from the user, the temperature of the interior volume of the container is independently controlled or the temperature of the module is independently controlled.

3. The appliance of claim 1, wherein the container further comprises a metering and dispensing mechanism positioned proximate the bottom portion of the container such that the mechanism regulates content output from the container when dry goods are disposed from the container, and wherein disposal of the dry goods is accessible from the interior or the exterior of the appliance when the module is engaged with the interior surface of the door.

4. The appliance of claim 1, wherein the module is removably engaged with the exterior surface or the interior surface of the door, wherein the module is capable of maintaining a storage effecting condition of the container that is different than the ambient conditions surrounding the module, wherein the storage effecting condition is chosen from the group consisting of humidity, temperature, pressure, gas composition, and combinations thereof, and wherein the humidity of the container is independently maintained by a humidity controller selected from the group consisting of a desiccant, a salt, or a heater.

5. The appliance of claim 3, wherein the metering and dispensing mechanism includes a user-interface that indicates a plurality of container content output amounts to the user, a handle on the exterior of the container, a shaft connected to the handle proximate a first end of the shaft and coupled to a gear system proximate the second end of the shaft, and a slide actuator operably engaged with the gear system, the slide actuator having at least one aperture, wherein rotation of the handle, shaft, and gear system, generates movement of the slide actuator to a position that corresponds to expelling of a user-desired output amount of the container interior volume.

6. The appliance of claim 3, wherein the metering and dispensing mechanism includes a user-interface display indicating a plurality of container content output amounts and the metering and dispensing device further includes at least one retractable receptacle having a manipulatable size that corresponds to a user-desired output amount of the container interior volume.

7. The appliance of claim 3, wherein the module includes a user-interface that indicates a plurality of user determined container output amounts and the metering and dispensing device further comprises a rotatable member operably engaged with the dispensing aperture along the bottom of the container having a plurality of substantially the same or the same sized dry goods receiving areas, a handle proximate a first end of a shaft and coupled to a gear system proximate the second end of the shaft and operably engaged with the rotatable member and the gear system such that when a user adjusts the amount to be dispensed using the user-interface, the gear system adjusts the rotational extent of the rotating member to dispense the output amount selected by the user.

8. The appliance of claim 4, wherein the door further comprises a module engaging connector for providing at least electrical power to the module and the module further comprises a utility connector that matingly engages the module engaging connector such that the module receives at least electrical power from the appliance when the module engaging connector and the utility connector are operably connected to one another.

9. The appliance of claim 8, wherein the container includes a sensor capable of indicating a user predetermined level of container contents, and wherein the module engages a plurality of resealable containers, and wherein the comestible dry goods are shifted by an agitating movement driver, wherein the agitating movement driver is chosen from the group consisting of a vibrating battery, off-center weighted motor, or manual movement.

10. A modular, portable dry goods storage and dispensing unit comprising:
a module housing having removable engagability to an interior surface of a refrigerator door, the interior surface having a door liner; and
a resealable comestible dry goods container having a defined interior volume, an exterior, and a bottom portion wherein the container is removably engageable with the module housing and positioned at least substantially within the housing when engaged with the module and wherein the container further comprises a metering and dispensing mechanism positioned proximate the bottom portion of the container such that the mechanism controls content output amount of the container interior volume, and wherein the module is capable of maintaining a storage effecting condition within the interior of the container, wherein the storage effecting condition is chosen from the group consisting of humidity, temperature, pressure, gas composition, and combinations thereof, and wherein temperature of the interior volume of the container is independently controlled and humidity of the container is independently maintained by a humidity controller selected from the group consisting of a desiccant, a salt, or a heater.

11. The portable dry goods storage and dispensing unit of claim 10, wherein the metering and dispensing mechanism includes a user-interface display on the exterior of the container indicating at least one container content output amount of the container interior volume, a handle on the exterior of the container, a shaft connected to the handle proximate a first end of the shaft and coupled to a gear system proximate the second end of the shaft, and a slide actuator operably engaged with the gear system, the slide actuator having at least one aperture, wherein rotation of the handle, shaft, and gear system generates movement of the slide actuator to a position that corresponds to expelling of a user-desired output amount of the container interior volume.

12. The portable dry goods storage and dispensing unit of claim 10, wherein the metering and dispensing mechanism comprises a user-interface display on the exterior of the container indicating at least one container content output amount of the container interior volume, wherein the container includes at least one retractable receptacle having a manipulatable size that corresponds to a user-desired output amount of the container interior volume.

13. The portable dry goods storage and dispensing unit of claim 10, wherein the module includes a utility connector that engages a power source, the module being supplied at least electrical power from the power source when the utility connector and the power source are operably connected to one another.

14. The portable dry goods storage and dispensing unit of claim 13, wherein the module includes a sensor capable of indicating a user predetermined level of container contents, and wherein the module is capable of engaging a plurality of the resealable comestible dry goods containers, and wherein the comestible dry goods are shifted by an agitating movement driver, wherein the agitating movement driver is chosen from the group consisting of a vibrating battery, off-center weighted motor, or manual movement.

15. The portable dry goods storage and dispensing unit of claim 10, wherein the module is engageable to a surface, wherein the surface is a countertop stand or a wall mount bracket.

16. A method for a user to store and dispense comestible dry goods comprising:
providing a refrigerator section within an appliance interior and having the same or a smaller volume than the interior; a door with an exterior surface and an interior surface, the interior surface having a door liner, the door further comprising a module engaging connector for providing at least electrical power; a module that is removably engageable with the appliance, the module further comprising a utility connector; a resealable comestible dry goods container having a defined interior volume, an exterior, and a bottom portion wherein the container is removably engageable within the module and wherein the container further comprises a metering and dispensing mechanism positioned proximate the bottom portion of the container such that the mechanism controls content output amount of the container interior volume;
engaging the module with the door, wherein the module engaging step includes operably connecting the module engaging connector to the module utility connector, thereby providing at least electrical power to the module;
engaging the resealable comestible dry goods container within the module, wherein the container engaging step includes inserting the container into a receiving port of the module;
specifying a desired content output amount of the container interior volume; and
metering and dispensing the desired volumetric output of the container interior volume.

17. The method for storing and dispensing dry goods of claim 16, wherein the step of specifying a desired content output amount of the container interior volume includes inputting the desired amount with a user-interface display on the exterior of the container.

18. The method for storing and dispensing dry goods of claim 16, wherein the module is capable of maintaining a storage effecting condition within the interior of the container, wherein the storage effecting condition is chosen from the group consisting of humidity, temperature, pressure, gas composition and combinations thereof, and wherein temperature of the interior volume of the container is independently controlled and humidity of the container is independently maintained by a humidity controller selected from the group consisting of a desiccant, a salt packet, or a heater and wherein the step of metering and dispensing the desired volumetric output of the container interior volume is capable of being done by a user through the exterior surface of the door or by accessing the interior of the appliance.

19. The method for storing and dispensing dry goods of claim 16, wherein the step of engaging the resealable container within the module takes place before the step of engaging the module with the door and the module is engaged with the door liner on the interior surface of the door.

20. The method for storing and dispensing dry goods of claim 16, further comprising the step of moving the door, wherein the movement shifts the comestible dry goods, and wherein the module is capable of engaging a plurality of resealable containers and wherein the step of metering and dispensing includes moving a handle on the exterior of the container.
